(19) United States
(12) Patent Application Publication
(10) Pub. No.: US 2007/0044134 A1
(43) Pub. Date: Feb. 22, 2007

(54) TELEVISION SIGNAL-RECEIVING MODULE

(76) Inventors: Yi-Jen Hu, Hsinchu (TW); Wei-Ming Lin, Hsinchu (TW); Yu-Hsin Feng, Hsinchu (TW)

Correspondence Address: NORTH AMERICA INTELLECTUAL PROPERTY CORPORATION, P.O. BOX 506, MERRIFIELD, VA, 22116, US

(21) Appl. No.: 11/426,019

(22) Filed: Jun. 23, 2006

(30) Foreign Application Priority Data
Jul. 12, 2005 (TW) 094123659

(51) Int. Cl. H04N 7/173; H04N 5/44; H04N 5/38; H04N 7/16

(52) U.S. Cl. 725/131; 348/723; 725/100; 348/725; 725/139

(57) ABSTRACT

A television signal-receiving module includes a first slot for disposing a network interface module detachably. The network interface module receives a television signal. The television signal-receiving module further includes a switch electrically connected to the network interface module for switching a transmission route of the television signal, a decoder electrically connected to the switch for decompressing and decoding the television signal, and a second slot for disposing a cable television decryptor detachably. The second slot is electrically connected to the decoder and the switch. The switch is switched to the decoder or the cable television decryptor so as to decode or decrypt the television signal after the network interface module downconverts and demodulates the television signal.

### BACKGROUND OF THE INVENTION

1. Field of the Invention

The present invention relates to a television signal-receiving module, and more particularly, to a television signal-receiving module capable of receiving television signals at different standards.

2. Description of the Prior Art

Please refer to FIG. 1. FIG. 1 is a functional block diagram of a television 10 at a first standard in the prior art. Radio frequency signals are received via an antenna 11 (or a cable) and transmitted to a signal-receiving module 12. A NTSC/ATSC network interface module 121 of the signal-receiving module 12 receives the radio frequency signals, such as NTSC analog signals of terrestrial broadcast and cable television and ATSC digital signals of terrestrial broadcast. The NTSC/ATSC network interface module 121 includes a tuner and a demodulator (not shown in FIG. 1). The tuner transforms the radio frequency signals into intermediate frequency signals. Then the demodulator demodulates the intermediate frequency signals so as to transform the intermediate frequency signals into baseband signals. The baseband signals include audio and image signals. Then a decoder 122 decompresses and decodes the baseband signals. The decoder 122 includes a MPEG-2 decoder 1221 and an image decoder 1222. The audio and image signals of the baseband signals are transmitted to a display device 13 (such as a LCD device, a plasma display panel, and a liquid crystal projector) and a speaker 14. A central processing unit 123 is electrically connected to the NTSC/ATSC network interface module 121 and the decoder 122 for controlling the NTSC/ATSC network interface module 121 and the decoder 122.

Please refer to FIG. 2. FIG. 2 is a functional block diagram of a television 20 at a second standard in the prior art. Radio frequency signals are received via an antenna 21 (or a cable) and transmitted to a signal-receiving module 22. A NTSC/ATSC/QAM network interface module 221 of the signal-receiving module 22 receives the radio frequency signals, such as NTSC analog signals of terrestrial broadcast and cable television, ATSC digital signals of terrestrial broadcast, and unencrypted digital cable television/QAM signals. The NTSC/ATSC/QAM network interface module 221 downconverts and demodulates the radio frequency signals into baseband signals and then transmits the baseband signals to a decoder 222. The decoder 222 decompresses and decodes the baseband signals. Audio and image signals of the baseband signals are transmitted to a display device 23 and a speaker 24. A central processing unit 223 is electrically connected to the NTSC/ATSC/QAM network interface module 221 and the decoder 222 for controlling the NTSC/ATSC/QAM network interface module 221 and the decoder 222.

Please refer to FIG. 3. FIG. 3 is a functional block diagram of a television 30 at a third standard in the prior art. Radio frequency signals are received via an antenna 31 (or a cable) and transmitted to a signal-receiving module 32. A NTSC/ATSC/QAM/OOB network interface module 321 of the signal-receiving module 32 receives the radio frequency signals, such as NTSC analog signals of terrestrial broadcast and cable television, ATSC digital signals of terrestrial broadcast, encrypted and unencrypted digital cable television/QAM signals, and management message. The OOB (out of band) signal includes the management message. The NTSC/ATSC/QAM/OOB network interface module 321 downconverts and demodulates the radio frequency signals into baseband signals and then transmits the baseband signals to a cable television decryptor 322. The cable television decryptor 322 decrypts the baseband signals and then transmits the decrypted baseband signals to a decoder 323. The decoder 323 decompresses and decodes the decrypted baseband signals. Audio and image signals of the decrypted baseband signals are transmitted to a display device 33 and a speaker 34. A central processing unit 324 is electrically connected to the NTSC/ATSC/QAM/OOB network interface module 321 and the decoder 322 for controlling the NTSC/ATSC/QAM/OOB network interface module 321 and the decoder 322.

The network interface module and the cable television decryptor of the conventional television are fixed on a circuit board of the signal-receiving module, and the network interface module only can receive television signals at a designated standard. Following the trend of television signal digitization, it is inconvenient for users to purchase a new television or a setup box for receiving television signals at different standards. There is a need to increase flexibility in receiving television signals at different standards of the television.

### SUMMARY OF THE INVENTION

It is a primary objective of the claimed invention to provide a television signal-receiving module capable of receiving television signals at different standards for solving the above-mentioned problem.

According to the claimed invention, a television signal-receiving module includes a first slot for disposing a network interface module detachably. The network interface module receives a television signal. The television signal-receiving module further includes a switch electrically connected to the network interface module for switching a transmission route of the television signal, a decoder electrically connected to the switch for decompressing and decoding the television signal, and a second slot for disposing a cable television decryptor detachably. The second slot is electrically connected to the decoder and the switch. The switch is switched to connect to the decoder or the cable television decryptor so as to decode or decrypt the television signal after the network interface module downconverts and demodulates the television signal.

According to the claimed invention, a television signal-receiving module includes a first slot for disposing a network interface module detachably. The network interface module receives a television signal. The television signal-receiving module further includes a switch electrically connected to the network interface module for switching a transmission route of the television signal, a decoder electrically connected to the switch for decompressing and decoding the television signals, and a cable television decryptor electrically connected to the decoder and the switch. The switch is switched to connect to the decoder or the cable television decryptor so as to decode or decrypt the television signal after the network interface module downconverts and demodulates the television signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a television at a first standard in the prior art.

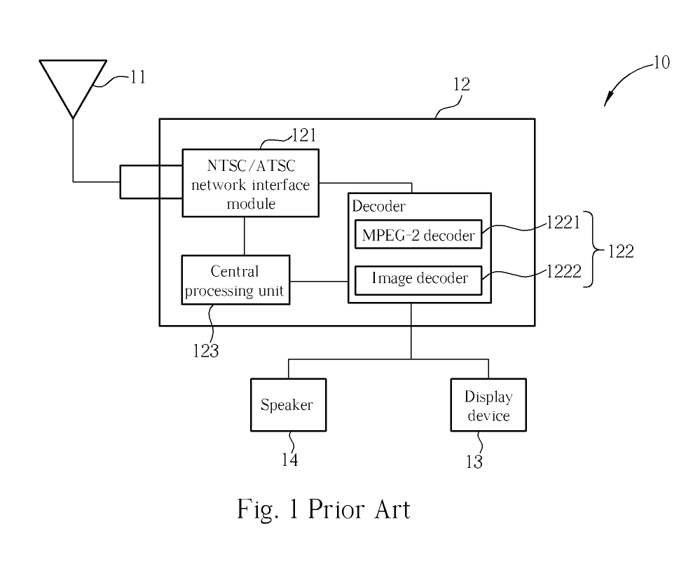

FIG. 2 is a functional block diagram of a television at a second standard in the prior art.

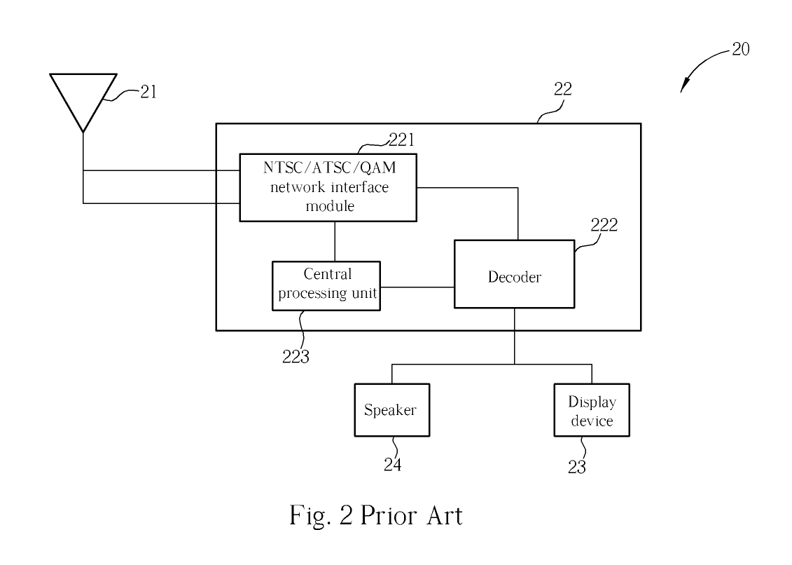

FIG. 3 is a functional block diagram of a television at a third standard in the prior art.

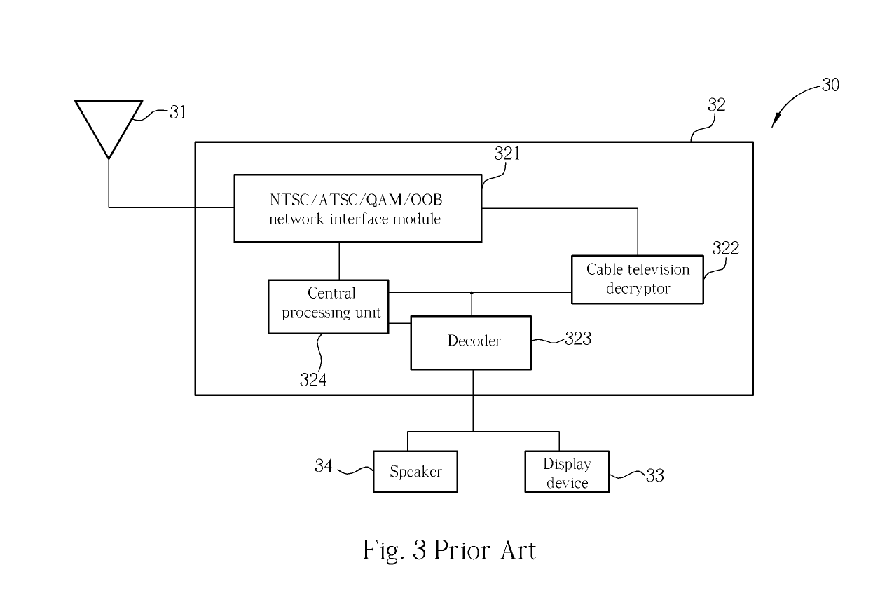

FIG. 4 is a functional block diagram of a television of an embodiment according to the present invention.

FIG. 5 is a functional block diagram of a television of another embodiment according to the present invention.

### DETAILED DESCRIPTION

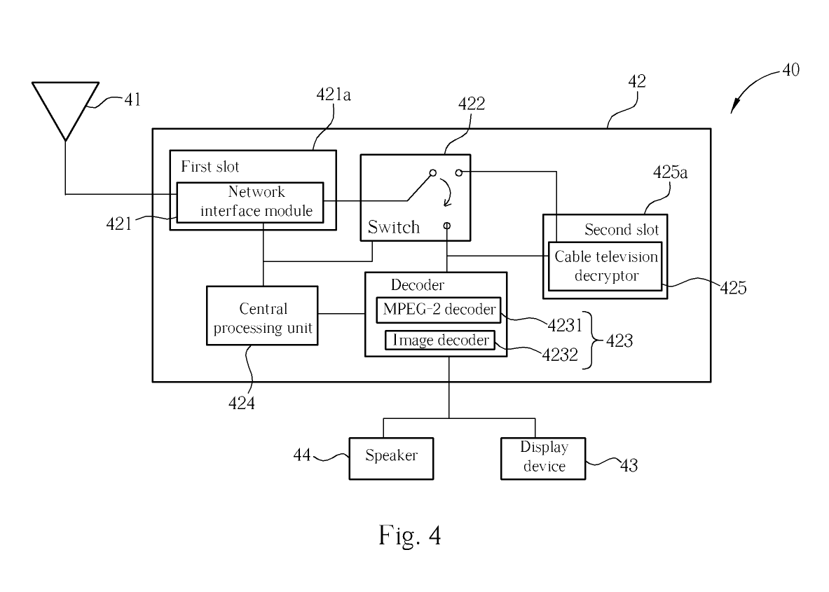

Please refer to FIG. 4. FIG. 4 is a functional block diagram of a television of an embodiment according to the present invention. A television 40 includes an antenna 41 (or a cable), a television signal-receiving module 42 electrically connected to the antenna 41, a display device 43 (such as a LCD device, a plasma display panel, and a liquid crystal projector), and a speaker 44. The television signal-receiving module 42 includes a network interface module 421, a first slot 421a, a switch 422 electrically connected to the network interface module 421, a decoder 423, and a central processing unit 424 electrically connected to the network interface module 421, the switch 422, and the decoder 423 for controlling the network interface module 421, the switch 422, and the decoder 423. The television signal-receiving module 42 further includes a cable television decryptor 425, and a second slot 425a. The network interface module 421 includes a tuner and a demodulator (not shown in FIG. 4). The decoder 423 includes a MPEG-2 decoder 4231 and an image decoder 4232. The network interface module 421 is disposed in the first slot 421a detachably for receiving television signals at all kinds of standards received by the antenna 41, such as NTSC analog signals of terrestrial broadcast and cable television, ATSC digital signals of terrestrial broadcast, cable television signals, encrypted and unencrypted digital cable television signals, management message, and so on. The cable television decryptor 425 is disposed in the second slot 425a detachably. The tuner of the network interface module 421 transforms the radio frequency signals received by the antenna 41 into intermediate frequency signals. Then the demodulator of the network interface module 421 demodulates the intermediate frequency signals so as to transform the intermediate frequency signals into baseband signals. The baseband signals include audio and image signals. Then the central processing unit 424 switches the switch 422 according to the type of the television signal received by the antenna 41 so as to switch a transmission route of the baseband signals. In this way, the baseband signals are transmitted to the decoder 423 directly, or transmitted to the cable television decryptor 425 first. And then the baseband signals are transmitted to the decoder 423. The audio and image signals of the baseband signals are transmitted to the display device 43 and the speaker 44 respectively. The central processing unit 424 can be integrated with the decoder 423.

When the television signal received by the antenna 41 corresponds with a first standard, the television signal includes NTSC analog signals of terrestrial broadcast and cable television or ATSC digital signals of terrestrial broadcast, the NTSC/ATSC network interface module 421 is disposed in the first slot 421a. It is no need to dispose the cable television decryptor 425 in the second slot 425a when the television signal does not include an encrypted signal. The tuner of the NTSC/ATSC network interface module 421 transforms the radio frequency signals received by the antenna 41 into intermediate frequency signals. Then the demodulator of the NTSC/ATSC network interface module 421 demodulates the intermediate frequency signals so as to transform the intermediate frequency signals into baseband signals. The baseband signals include audio and image signals. The central processing unit 424 switches the switch 422 so as to transmit the baseband signals to the decoder 423 directly. The decoder 423 decompresses and decodes the audio and image signals of the baseband signals, and then the audio and image signals are transmitted to the display device 43 and the speaker 44 respectively.

When the television signal received by the antenna 41 corresponds with the second standard, the television signal includes NTSC analog signals of terrestrial broadcast or cable television, ATSC digital signals of terrestrial broadcast, or unencrypted digital cable television/QAM signals, the NTSC/ATSC/QAM network interface module 421 is disposed to the first slot 421a. There is no need to dispose the cable television decryptor 425 in the second slot 425a when the television signal does not include an encrypted signal. The tuner of the NTSC/ATSC/QAM network interface module 421 transforms the radio frequency signals received by the antenna 41 into intermediate frequency signals. Then the demodulator of the NTSC/ATSC/QAM network interface module 421 demodulates the intermediate frequency signals so as to transform the intermediate frequency signals into baseband signals. The baseband signals include audio and image signals. The central processing unit 424 switches the switch 422 so as to transmit the baseband signals to the decoder 423 directly. The decoder 423 decompresses and decodes the audio and image signals of the baseband signals, and then the audio and image signals are transmitted to the display device 43 and the speaker 44 respectively.

When the television signal received by the antenna 41 corresponds with the third standard, the television signal includes NTSC analog signals of terrestrial broadcast and cable television, ATSC digital signals of terrestrial broadcast, unencrypted or encrypted digital cable television/QAM signals, or management messages, the NTSC/ATSC/QAM/OOB network interface module 421 is disposed in the first slot 421a. Furthermore, the cable television decryptor 425 is disposed in the second slot 425a. The central processing unit 424 switches the switch 422 to connect with the cable television decryptor 425. The tuner and the demodulator of the NTSC/ATSC/QAM network interface module 421 downconvert and demodulate the radio frequency signals received by the antenna 41 into baseband signals. When receiving the encrypted digital cable television signal, the central processing unit 424 switches the switch 422 to connect the NTSC/ATSC/QAM network interface module 421 and the cable television decryptor 425 and controls the cable television decryptor 425 to decrypt the baseband signals. The decoder 423 decompresses and decodes the baseband signals, and then audio and image signals are transmitted to the display device 43 and the speaker 44 respectively. When receiving the unencrypted ATSC/Cable(QAM) signals, the central processing unit 424 switches the switch 422 to connect the NTSC/ATSC/QAM network interface module 421 and the decoder 423 so that the baseband signals downconverted and demodulated by the NTSC/ATSC/QAM/OOB network interface module 421 are transmitted to the decoder 423 directly. The decoder 423 decompresses and decodes the baseband signals, and then audio and image signals of the baseband signals are transmitted to the display device 43 and the speaker 44 respectively.

The different network interface modules can be disposed in the first slot 421a according to the transmission standard of the television signal or design demand for receiving television signals at different standards. In addition, the cable television decryptor 425 is disposed in the second slot 425a selectively according to whether the television signal includes encrypted cable television signals. The present invention increases flexibility in receiving television signals at different standards of the television and can upgrade the television easily.

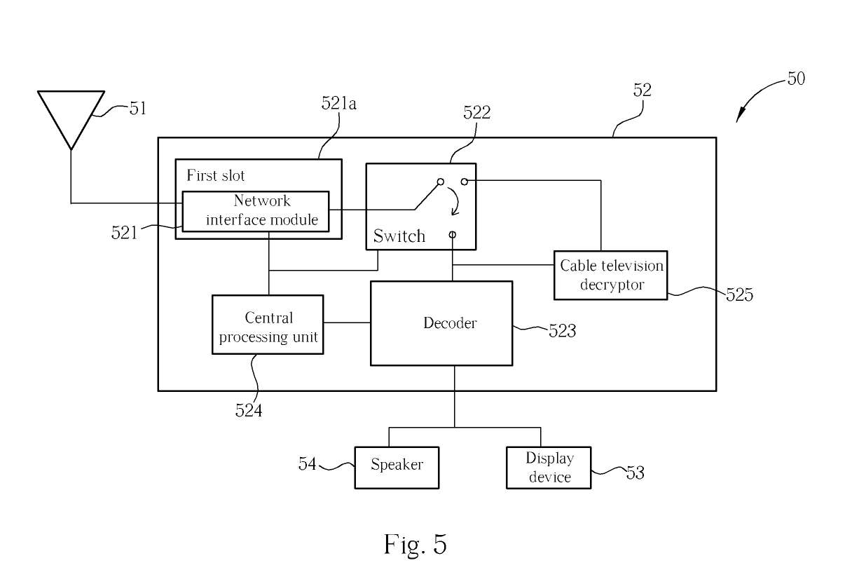

Please refer to FIG. 5. FIG. 5 is a functional block diagram of a television 50 of another embodiment according to the present invention. A difference between FIG. 4 and FIG. 5 is that a cable television decryptor 525 is installed inside a television signal-receiving module 52 directly. The television 50 includes the television signal-receiving module 52, a display device 53, and a speaker 54. The television signal-receiving module 52 includes a network interface module 521, a first slot 521a, a switch 522 electrically connected to the network interface module 521, a decoder 523, and a central processing unit 524 electrically connected to the network interface module 521, the switch 522, and the decoder 523 for controlling the network interface module 521, the switch 522, and the decoder 523. A tuner and a demodulator of the network interface module 521 downconvert and demodulate the radio frequency signals into the baseband signals. The central processing unit 524 switches the switch 522 to switch a transmission route of the television signal according to the selected network interface module 521. The baseband signals are transmitted to the decoder 523 directly. Otherwise the baseband signals are transmitted to the cable television decryptor 425, decrypted by the cable television decryptor 425, and then transmitted the decrypted baseband signals to the decoder 523. Audio and image signals of the baseband signals or the decrypted baseband signals are transmitted to the display device 53 and the speaker 54 respectively.

In contrast to the conventional television, the present invention increases flexibility in receiving television signals at different standards of the television and can upgrade the television easily.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A television signal-receiving module comprising:
a first slot adapted for disposing a network interface module detachably, the network interface module receiving a television signal and the network interface module downconverting and demodulating the television signal;
a switch electrically connected to the network interface module for switching a transmission route of downconverted and demodulated television signal;
a decoder electrically connected to the switch for decompressing and decoding the downconverted and demodulated television signals; and
a second slot adapted for disposing a cable television decryptor detachably, the second slot electrically connecting to the decoder and the switch respectively.

2. The television signal-receiving module of claim 1 wherein the network interface module is exchangeable according to the television signal.

3. The television signal-receiving module of claim 1 wherein the network interface module is a NTSC/ATSC network interface module disposed in the first slot and the television signal comprises NTSC analog signals of terrestrial broadcast or cable television or ATSC digital signals of terrestrial broadcast.

4. The television signal-receiving module of claim 1 wherein the network interface module is a NTSC/ATSC/QAM network interface module disposed in the first slot and the television signal comprises NTSC analog signals of terrestrial broadcast and cable television, ATSC digital signals of terrestrial broadcast, or unencrypted digital cable television signals.

5. The television signal-receiving module of claim 1 wherein the network interface module is a NTSC/ATSC/QAM/OOB network interface module disposed in the first slot and the television signal comprises NTSC analog signals of terrestrial broadcast and cable television, ATSC digital signals of terrestrial broadcast, encrypted and unencrypted digital cable television signals, or management messages.

6. The television signal-receiving module of claim 5 wherein the cable television decryptor is disposed in the second slot.

7. The television signal-receiving module of claim 1 wherein the decoder comprises a MPEG-2 decoder and an image decoder.

8. The television signal-receiving module of claim 1 further comprising a central processing unit electrically connected to the network interface module, the decoder, and the cable television decryptor for controlling the network interface module, the decoder, and the cable television decryptor.

9. The television signal-receiving module of claim 1 further comprising a central processing unit integrated with the decoder.

10. The television signal-receiving module of claim 1 wherein the television signal is received by an antenna or a cable.

11. A television signal-receiving module comprising:
a first slot adapted for disposing a network interface module detachably, the network interface module receiving a television signal, and the network interface module downconverting and demodulateing the television signal;
a switch electrically connected to the network interface module for switching a transmission route of downconverted and demodulated television signal;
a decoder electrically connected to the switch for decompressing and decoding the downconverted and demodulated television signal; and
a cable television decryptor electrically connected to the decoder and the switch.

12. The television signal-receiving module of claim 11 wherein the network interface module is a NTSC/ATSC network interface module disposed in the first slot and the television signal comprises NTSC analog signals of terrestrial broadcast or cable television or ATSC digital signals of terrestrial broadcast.

13. The television signal-receiving module of claim 11 wherein the network interface module is a NTSC/ATSC/QAM network interface module disposed in the first slot and the television signal comprises NTSC analog signals of terrestrial broadcast or cable television, ATSC digital signals of terrestrial broadcast, or unencrypted digital cable television signals.

14. The television signal-receiving module of claim 11 wherein the network interface module is a NTSC/ATSC/QAM/OOB network interface module disposed in the first slot and the television signal comprises NTSC analog signals of terrestrial broadcast or cable television, ATSC digital signals of terrestrial broadcast, encrypted and unencrypted digital cable television signals, or management messages.

15. The television signal-receiving module of claim 11 wherein the decoder comprises a MPEG-2 decoder and an image decoder.

16. The television signal-receiving module of claim 11 further comprising a central processing unit electrically connected to the network interface module, the decoder, and the cable television decryptor for controlling the network interface module, the decoder, and the cable television decryptor.

17. The television signal-receiving module of claim 11 further comprising a central processing unit integrated with the decoder.
